(19) United States
(12) Patent Application Publication
(10) Pub. No.: US 2023/0377434 A1
(43) Pub. Date: Nov. 23, 2023

(54) METHODS AND SYSTEMS FOR REDUCING REDUNDANT ALARM NOTIFICATIONS IN A SECURITY SYSTEM

(71) Applicant: Honeywell International Inc., Charlotte, NC (US)

(72) Inventors: Lalitha M. Eswara, Bangalore (IN); Siddharth Baliram Sonkamble, Mumbai (IN); Ayan Maiti, West Bengal (IN); Bhupesh Kumar Koli, Bangalore (IN)

(21) Appl. No.: 17/746,558

(22) Filed: May 17, 2022

(51) Int. Cl. G08B 13/196; G08B 13/189

(52) U.S. Cl. CPC G08B 13/19641; G08B 13/19608; G08B 13/1895; G08B 13/1968

(57) ABSTRACT

A method for reducing alarm notifications from a security system deploying a plurality of cameras within a monitored area includes processing a first video stream captured by the first camera of the security system to detect an alarm event observed in the Field of View (FOV) of the first camera and processing a second video stream captured by a second camera of the security system to detect the same alarm event observed in the FOV of the second camera. A combined alarm notification corresponding to the alarm event is sent, wherein the combined alarm notification includes the alarm event and may identify the first camera and the second camera as both detecting the same alarm event in their respective FOVs.

### TECHNICAL FIELD

The present disclosure pertains generally to security systems and more particularly to reducing redundant alarm notifications within a security system.

### BACKGROUND

A security system may include a number of video cameras within a monitored area. The monitored area may be indoors or outdoors, for example. Each video camera has a field of view (FOV) that describes what that particular video camera can see. If an object is within the FOV of a particular video camera, and that particular video camera is operating, the object will be captured in the video stream of that particular video camera. It will be appreciated that in some cases, the FOV of a first camera of a security system may overlap with the FOV of a second camera of the security system in an overlapping FOV region. The overlap may be minor, or the overlap may be substantial. If each video camera is executing video analytics on their respective video streams, or if a remote device (e.g. remote server) is executing video analytics on the respective video streams, and a security event occurs in the overlapping FOV region of the respective video streams, the video analytics associated with each of the video streams may issue an alarm for the same security event. These alarms may be considered redundant alarms because they both related to the same security event, just captured by different cameras. This can significantly increase the workload to a security operator monitoring the security system, and in some cases, may draw the operator's attention away from other security events. What would be beneficial are improved methods and systems for detecting security cameras that have overlapping FOVs, and to reduce or eliminate redundant alarms that correspond to the same security event captured by multiple cameras in an overlapping FOV.

### SUMMARY

This disclosure relates generally to improved methods and systems for detecting cameras with overlapping FOVs in order to reduce redundant alarm notifications in a security system. An example may be found in a method for reducing alarm notifications from a security system deploying a plurality of cameras within a monitored area. A first camera of the plurality of cameras has a first field of view (FOV) and a second camera of the plurality of cameras has a second FOV, wherein at least part of the first FOV of the first camera includes a first overlapping region that corresponds to where the second FOV of the second camera overlaps with the first FOV of the first camera. At least part of the second FOV of the second camera includes a second overlapping region that corresponds to where the first FOV of the first camera overlaps with the second FOV of the second camera. The method includes processing a first video stream captured by the first camera of the security system to detect an alarm event observed in the first overlapping region of the FOV of the first camera and processing a second video stream captured by the second camera of the security system to detect the same alarm event observed in the second overlapping region of the FOV of the second camera. A combined alarm notification corresponding to the alarm event is sent, wherein the combined alarm notification includes the alarm event and identifies the first camera and the second camera as both detecting the alarm event in their respective FOVs.

Another example may be found in a method for reducing alarm notifications from a security system deploying a plurality of cameras within a monitored area, at least some of the plurality of cameras having a field of view (FOV) that overlaps with that of at least one other of the plurality of cameras. The illustrative method includes receiving video frames from each of a first camera having a first FOV and a second camera having a second FOV, where a determination has been made that the first FOV overlaps with the second FOV. One or more objects are detected within the video frames from the first camera. At the same time, at least one of the same one or more objects are detected within the video frames from the second camera. An overlapping region between the first FOV and the second FOV is determined based at least in part on the one or more detected object. An alarm event is detected in the overlapping region between the first FOV and the second FOV. A combined alarm notification corresponding to the alarm event is sent.

Another example may be found in a method for finding an overlap region between a field of view (FOV) of a first camera and a FOV of a second camera. The method includes determining that the FOV of the first camera overlaps with the FOV of the second camera. Video frames from the first camera having a first FOV and video frames from the second camera having a second FOV are received. One or more moving people are found within the video frames from the first camera. At least one of the same one or more moving people are found within the video frames from the second camera. Over time, the at least one of the same one or more moving people are tracked through subsequent video frames from each of the first camera and the second camera. The tracking is used to define an overlap region in which the FOV of the first camera overlaps the FOV of the second camera and/or the an overlap region in which the FOV of the second camera overlaps the FOV of the first camera.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative security system;

FIG. 2 is a schematic diagram showing a field of view (FOV) of a first video camera overlapping with a FOV of a second video camera;

FIG. 3 is a flow diagram showing an illustrative method for reducing alarm notifications;

FIG. 4 is flow diagram showing an illustrative method for reducing alarm notifications;

FIG. 5 is a flow diagram showing an illustrative method for automatically defining overlapping regions;

FIG. 6 is a flow diagram showing an illustrative method for automatically defining overlapping regions;

FIG. 7 is a flow diagram showing an illustrative method for reducing alarm notifications;

FIG. 8 is a flow diagram showing an illustrative method for reducing alarm notifications;

FIG. 9 is a flow diagram showing an illustrative method for determining an overlapping region;

FIG. 10 is a flow diagram showing an illustrative method for determining an overlapping region;

FIGS. 11A and 11B are flow diagrams that together show an illustrative method for finding an overlap region between a FOV of a first camera and a FOV of a second camera;

FIG. 12 is a flow diagram showing an illustrative method;

FIG. 13 is a flow diagram showing an illustrative method;

FIG. 14 is a flow diagram showing an illustrative method;

FIG. 15 is a flow diagram showing an illustrative method; and

FIG. 16 is a flow diagram showing an illustrative method.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

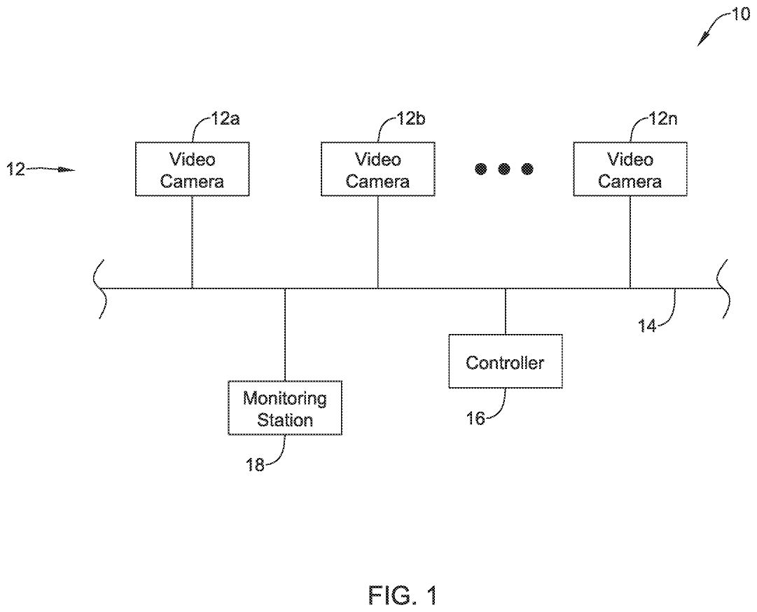

FIG. 1 is a schematic block diagram showing an illustrative security system 10. The illustrative security system 10 includes a plurality of video cameras 12, individually labeled as 12a, 12b through 12n. The security system 10 may have any number of video cameras 12. In the illustrative system, each of the video cameras 12 are operably coupled to a network 14. The network 14 may be a wired network. The network 14 may be a wireless network, or a combination wired and wireless network. Each of the video cameras 12 are operably coupled, via the network 14, with a controller 16. In some instances, the controller 16 may control operation of at least some of the video cameras 12. For example, when at least some of the video cameras 12 are pan-tilt-zoom (PTZ) cameras, the controller 16 may instruct the PTZ cameras to make changes to one or more of their pan, tilt and/or zoom settings to adjust the FOV of those cameras as needed.

In some cases, the controller 16 may receive video streams from the video cameras 12 over the network 14, and may perform video analytics on those video streams. In some cases, at least some of the video cameras 12 may be configured to perform video analytics on their own video streams. In some cases, the video analytics may be split between the video cameras 12 and the controller 16, depending at least in part upon the capabilities of the video cameras 12. The controller 16 may be located close to at least some of the video cameras 12, such as at the edge. In some instances, the controller 16 may be remote from the video cameras 12, such as on the cloud. In some cases, the security system 10 includes a monitoring station 18 that is operably coupled with the controller 16 via the network 14. This is just one example security system configuration.

The monitoring station 18 may receive alarms from the controller 16 when the controller 16 detects a possible security event in one or more video streams provided to the controller 16 from one or more of the video cameras 12. In situations in which at least some of the video cameras 12 (or intervening edge devices) are performing video analytics on their own video streams, the monitoring station 18 may receive alarms from those video cameras 12. The monitoring station 18 may be local to where the video cameras 12 are located (e.g. in same facility), or the monitoring station 18 may be remote (e.g. remote from the facility). The monitoring station 18 may be configured to display video streams, or clips from video streams, for review by security personnel. In some cases, the monitoring station 18 may display video so that the security personnel are able to verify, or perhaps dismiss, possible alarms that have been received by the monitoring station 18, regardless of whether those alarms were raised by one or more video cameras 12 or by the controller 16.

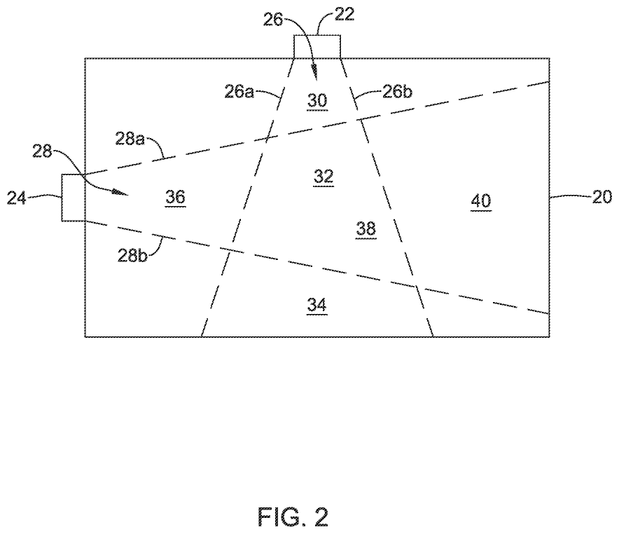

FIG. 2 is a schematic diagram showing an illustrative monitored area 20 that includes a first video camera 22 and a second video camera 24. The first video camera 22 and the second video camera 24 are shown as being located on adjacent sides of the monitored area 20, but this is merely illustrative. It will be appreciated that the first video camera 22 and the second video camera 24 may be located anywhere within or near the monitored area 20. In some cases, the monitored area 20 may include additional video cameras. As seen, the first video camera 22 has a FOV 26 that is shown as extending between a pair of dashed lines 26a and 26b, with the FOV 26 expanding with increasing distance from the first video camera 22. The second video camera 24 has a FOV 28 that is shown as extending between a pair of dashed lines 28a and 28b, with the FOV 28 expanding with increasing distance from the second video camera 24. In some cases, the FOV 26 and/or the FOV 28 may expand more rapidly than shown with increasing distance from the first video camera 22 and/or the second video camera 24. In some instances, the FOV 26 and/or the FOV 28 may expand less rapidly than shown with increasing distance from the first video camera 22 and/or the second video camera 24.

For pan-tilt-zoom cameras, the FOV 26 and/or the FOV 28 may expand less or more rapidly than shown with increasing distance from the first video camera 22 and/or the second video camera 24 depending on zoom setting for each of the first video camera 22 and/or the second video camera 24. Also, the position/orientation of the FOV 26 and/or the FOV 28 may change depending on a pan and/or tilt setting for each of the first video camera 22 and/or the second video camera 24.

As shown, the FOV 26 (of the first video camera 22) may be divided into a region 30, a region 32 and a region 34 while the FOV 28 (of the second video camera 24) may be divided into a region 36, a region 38 and a region 40. It will be appreciated that the region 32 (of the FOV 26) is the same as the region 38 (of the FOV 28). Accordingly, any activity that occurs within this shared region 32, 38 is visible to both the first video camera 22 and the second video camera 24. Any activity that occurs within the region 30 or the region 34 is visible to the first video camera 22 but not the second video camera 24. Any activity that occurs within the region 36 or the region 40 is visible to the second video camera 24 but not the first video camera 22. Areas of the monitored area 20 that are outside of the FOV 26 and the FOV 28 are not visible to either the first video camera 22 or the second video camera 24, and presumably are within a FOV of other video cameras (not illustrated).

If suspicious activity is detected within the region 30 or the region 34, such activity will be detected by the first video camera 22 and possibly (if necessary) reported such as by alarm. If suspicious activity is detected within the region 36 or the region 40, such activity will be detected by the second video camera 24 and possibly (if necessary) reported such as by alarm. However, any suspicious activity that is detected within the shared region 32, 38 will be detected by the first video camera 22 and the second video camera 24, and thus could be reported by separate alarms by both the first video camera 22 and the second video camera 24. It will be appreciated that if both the first video camera 22 and the second video camera 24 report the same event, a single event will appear to be two distinct events reported by two distinct alarms. This can double (or more) the events that need to be checked out by an operator at the monitoring station 18, for example. In some cases, determining where the FOV of the first video camera 22 overlaps with the FOV of the second video camera 24 (or any other video cameras not shown) is useful in limiting redundant event reporting.

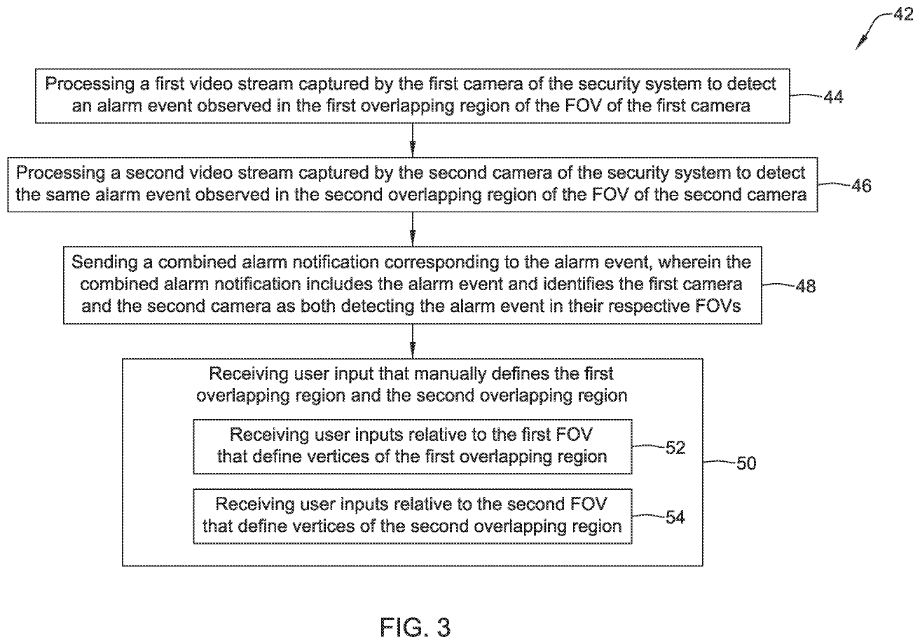

FIG. 3 is a flow diagram showing an illustrative method 42 for reducing alarm notifications from a security system (such as the security system 10) deploying a plurality of cameras (such as the video cameras 12) within a monitored area (such as the monitored area 20). A first camera of the plurality of cameras has a first field of view (FOV) and a second camera of the plurality of cameras has a second FOV, wherein at least part of the first FOV of the first camera includes a first overlapping region that corresponds to where the second FOV of the second camera overlaps with the first FOV of the first camera, and wherein at least part of the second FOV of the second camera includes a second overlapping region that corresponds to where the first FOV of the first camera overlaps with the second FOV of the second camera. The illustrative method 42 includes processing a first video stream captured by the first camera of the security system to detect an alarm event observed in the first overlapping region of the FOV of the first camera, as indicated at block 44. A second video stream captured by the second camera of the security system is processed to detect the same alarm event (e.g. same object at same time) observed in the second overlapping region of the FOV of the second camera, as indicated at block 46. A combined alarm notification corresponding to the alarm event is sent, wherein the combined alarm notification includes the alarm event and identifies the first camera and the second camera as both detecting the alarm event in their respective FOVs, as indicated at block 48.

In some instances, the method 42 may further include receiving user input that manually defines the first overlapping region and the second overlapping region, as indicated at block 50. As an example, and in some cases, receiving user input that manually defines the first overlapping region and the second overlapping region includes receiving user inputs relative to the first FOV that define vertices of the first overlapping region, as indicated at block 52, and receiving user inputs relative to the second FOV that define vertices of the second overlapping region, as indicated at block 54.

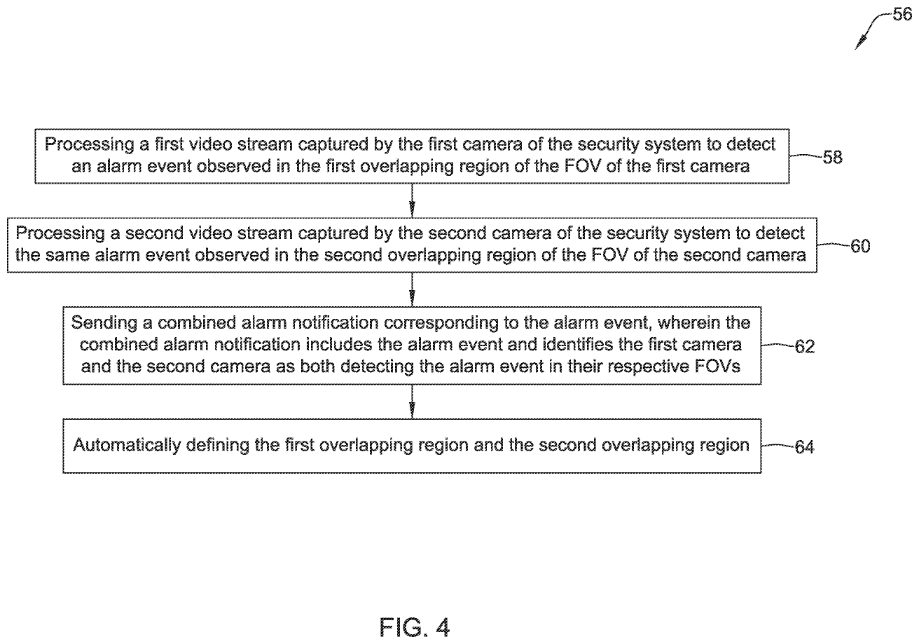

FIG. 4 is a flow diagram showing an illustrative method 56 for reducing alarm notifications from a security system (such as the security system 10) deploying a plurality of cameras (such as the video cameras 12) within a monitored area (such as the monitored area 20). A first camera of the plurality of cameras has a first field of view (FOV) and a second camera of the plurality of cameras has a second FOV, wherein at least part of the first FOV of the first camera includes a first overlapping region that corresponds to where the second FOV of the second camera overlaps with the first FOV of the first camera, and wherein at least part of the second FOV of the second camera includes a second overlapping region that corresponds to where the first FOV of the first camera overlaps with the second FOV of the second camera.

The illustrative method 56 includes processing a first video stream captured by the first camera of the security system to detect an alarm event observed in the first overlapping region of the FOV of the first camera, as indicated at block 58. In some instances, the method 56 may further include identifying the nearby cameras of the first camera of the security system in order to identify the second camera of the securing system using either manual or automatic self-discovery methods. A second video stream captured by the second camera of the security system is processed to detect the same alarm event (e.g. same object at same time) observed in the second overlapping region of the FOV of the second camera, as indicated at block 60. A combined alarm notification corresponding to the alarm event is sent. In some cases, the combined alarm notification includes the alarm event and identifies the first camera and the second camera as both detecting the alarm event in their respective FOVs, as indicated at block 62, but this is not required. In some cases, the method 56 further includes automatically defining the first overlapping region and the second overlapping region, as indicated at block 64.

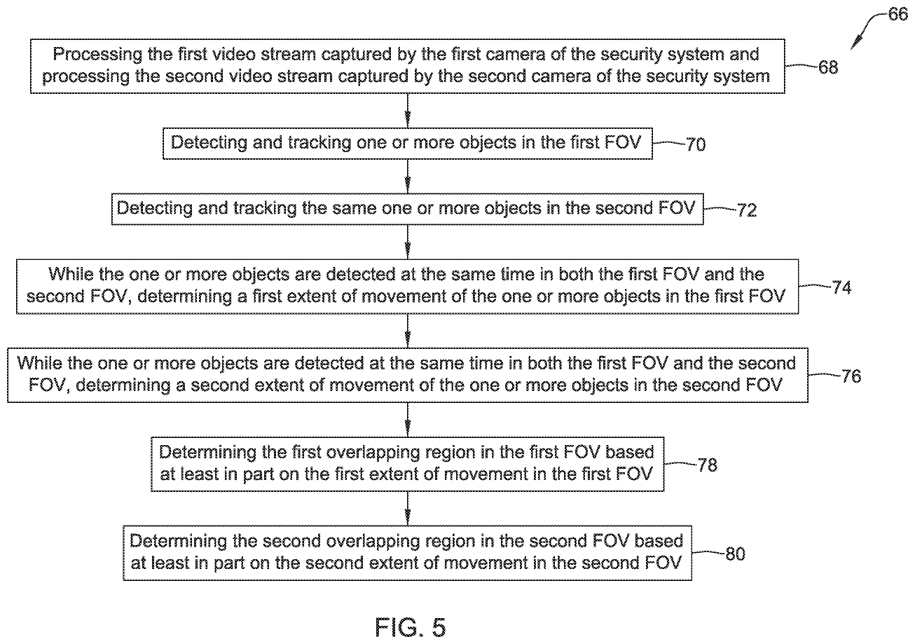

FIG. 5 is a flow diagram showing an illustrative method 66 of automatically defining the first overlapping region and the second overlapping region, and thus may be considered as being an example of the process indicated at block 64 of FIG. 4. The illustrative method 66 includes processing the first video stream captured by the first camera of the security system and processing the second video stream captured by the second camera of the security system, as indicated at block 68. One or more objects are detected and tracked in the first FOV, as indicated at block 70. The same one or more objects are detected and tracked in the second FOV, as indicated at block 72. While the one or more objects are detected at the same time in both the first FOV and the second FOV, a first extent of movement of the one or more objects in the first FOV is detected over a period of time, as indicated at block 74. In some cases, the extent of movement may refer to the object's location on the ground. While the one or more objects are detected at the same time in both the first FOV and the second FOV, determining a second extent of movement of the one or more objects in the second FOV is detected over the period of time, as indicated at block 76. The first overlapping region in the first FOV is determined based at least in part on the first extent of movement in the first FOV, as indicated at block 78. The second overlapping region in the second FOV is determined based at least in part on the second extent of movement in the second FOV, as indicated at block 80. When the object is seen in the first FOV and the second FOV at the same time, the extent of movement in both FOV refer to one location of ground point in the real world. If an alarm occurs in these extents of movement or locations, only one alarm, which is the combined alarm, is triggered, thus reducing redundant alarms. In some cases, the period of time that the extend of movement of the objects in the first FOV and/or second FOV are determined may be, for example, one hour, one day, one week, one month, or any other suitable time period. In some cases, the extend of movement of the objects in the first FOV and/or second FOV may be determined repeatedly during normal operation of the security system to continually update the first and second overlapping regions over time. This may be particularly useful when, for example, one of the first FOV and/or second FOV were to change (e.g. the first or second camera was bumped or otherwise moved).

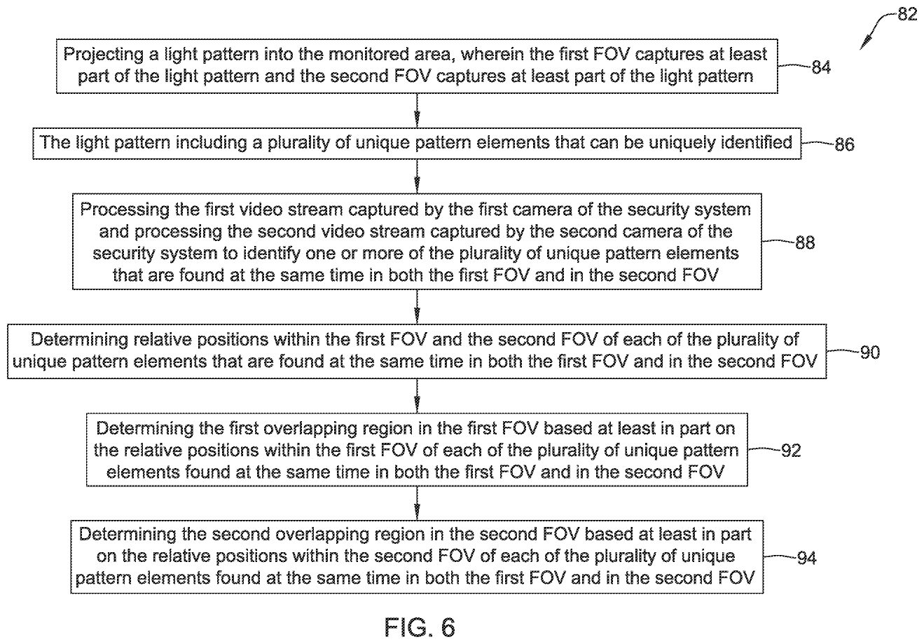

FIG. 6 is a flow diagram showing an illustrative method 82 of automatically defining the first overlapping region and the second overlapping region, and thus may be considered as being an example of the process as indicated at block 64 of FIG. 4. The illustrative method 82 includes projecting a light pattern into the monitored area, wherein the first FOV captures at least part of the light pattern and the second FOV captures at least part of the light pattern, as indicated at block 84. As an example, the light pattern may include a sequence of light patterns, wherein the sequence of light patterns includes two or more different light patterns.

The light pattern includes a plurality of unique pattern elements that can be uniquely identified, as indicated at block 86. The first video stream captured by the first camera of the security system and the second video stream captured by the second camera of the security system are processed to identify one or more of the plurality of unique pattern elements that are found in both the first FOV and in the second FOV at the same time, as indicated at block 88. Relative positions within the first FOV and the second FOV of each of the plurality of unique pattern elements that are found at the same time in both the first FOV and in the second FOV are determined, as indicated at block 90. The first overlapping region in the first FOV is determined based at least in part on the relative positions within the first FOV of each of the plurality of unique pattern elements found at the same time in both the first FOV and in the second FOV, as indicated at block 92. The second overlapping region in the second FOV is determined based at least in part on the relative positions within the second FOV of each of the plurality of unique pattern elements found at the same time in both the first FOV and in the second FOV, as indicated at block 94.

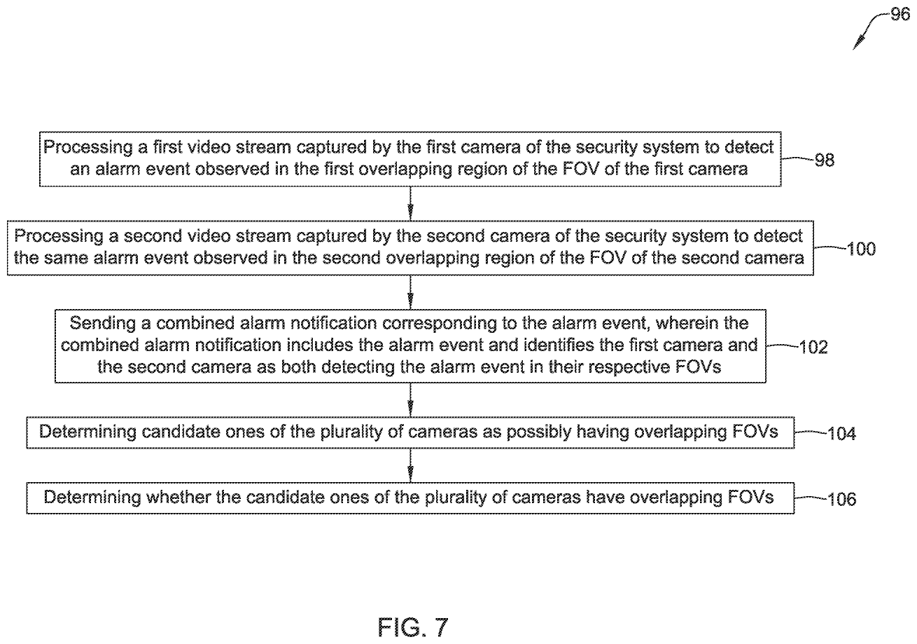

FIG. 7 is a flow diagram showing an illustrative method 96 for reducing alarm notifications from a security system (such as the security system 10) deploying a plurality of cameras (such as the video cameras 12) within a monitored area (such as the monitored area 20). A first camera of the plurality of cameras has a first field of view (FOV) and a second camera of the plurality of cameras has a second FOV, wherein at least part of the first FOV of the first camera includes a first overlapping region that corresponds to where the second FOV of the second camera overlaps with the first FOV of the first camera, and wherein at least part of the second FOV of the second camera includes a second overlapping region that corresponds to where the first FOV of the first camera overlaps with the second FOV of the second camera. The illustrative method 96 includes processing a first video stream captured by the first camera of the security system to detect an alarm event observed in the first overlapping region of the FOV of the first camera, as indicated at block 98. A second video stream captured by the second camera of the security system is processed to detect the same alarm event observed in the second overlapping region of the FOV of the second camera, as indicated at block 100. A combined alarm notification corresponding to the alarm event is sent. In some cases, the combined alarm notification includes the alarm event and identifies the first camera and the second camera as both detecting the alarm event in their respective FOVs, as indicated at block 102.

In some instances, the illustrative method 96 further include determining candidate ones of the plurality of cameras as possibly having overlapping FOVs, as indicated at block 104. The method 96 may further include determining whether the candidate ones of the plurality of cameras have overlapping FOVs, as indicated at block 106. In some cases, determining candidate ones of the plurality of cameras as possibly having overlapping FOVs may include identifying cameras that are neighboring cameras in the security system. In some cases, the neighboring cameras may be identified by a self-discovery module. In some cases, the self-discovery module can receive inputs from previously known knowledge, a building map, or a spatial or hierarchal mapping of the cameras. Once candidate ones of the plurality of cameras as possibly having overlapping FOVs are identified, one or more of the illustrative methods of, for example, FIG. 5-6, 9-10, or 11A-11B may be invoked to determine the extent of overlapping FOVs between the candidate ones of the plurality of cameras, if any.

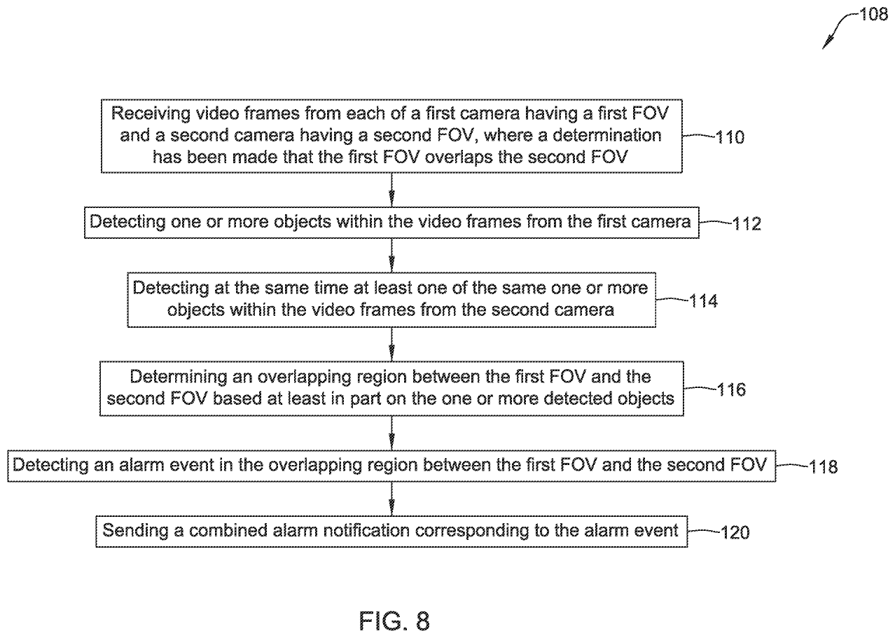

FIG. 8 is a flow diagram showing an illustrative method 108 for reducing alarm notifications from a security system (such as the security system 10) deploying a plurality of cameras (such as the video cameras 12) within a monitored area (such as the monitored area 20). At least some of the plurality of cameras have a field of view (FOV) that overlaps with that of at least one other of the plurality of cameras. The illustrative method 108 includes receiving video frames from each of a first camera having a first FOV and a second camera having a second FOV, where a determination has been made that the first FOV overlaps the second FOV, as indicated at block 110. One or more objects are detected within the video frames from the first camera, as indicated at block 112. At least one of the same one or more objects are found to be present at the same time (e.g. same time stamp) within the video frames from the second camera, as indicated at block 114.

An overlapping region between the first FOV and the second FOV is determined based at least in part on the one or more detected objects, as indicated at block 116. In some cases, determining the overlapping region may include fine tuning the overlapping region as additional objects are found within the FOV of the first camera and the same additional objects are found to be present at the same time (e.g. same time stamp) within the FOV of the second camera.

An alarm event is detected in the overlapping region between the first FOV and the second FOV, as indicated at block 118. A combined alarm notification corresponding to the alarm event is sent, as indicated at block 120. In some instances, the combined alarm notification may include the alarm event and may identify the first camera and the second camera as both detecting the alarm event in their respective FOVs.

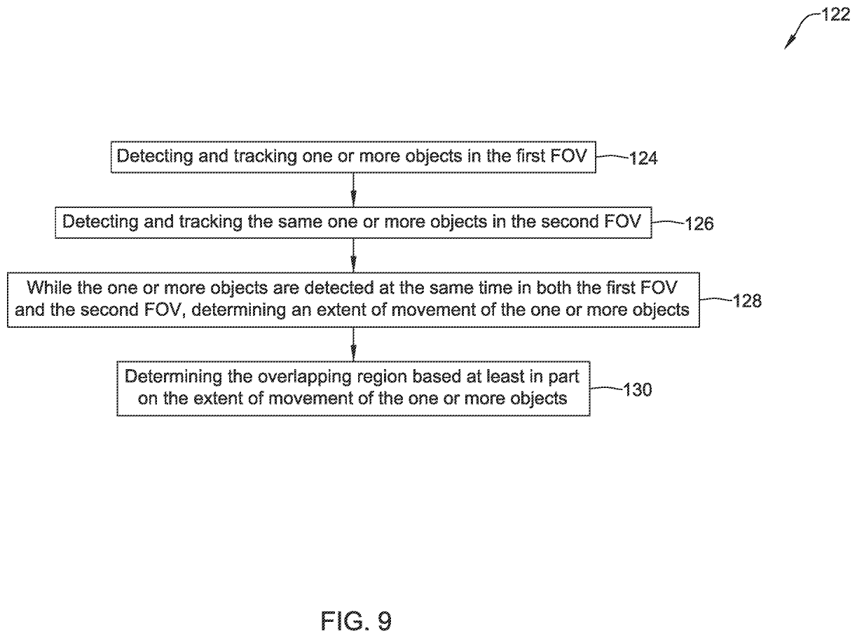

FIG. 9 is a flow diagram showing an illustrative method 122 of determining the overlapping region between the first FOV and the second FOV. The illustrative method 122 includes detecting and tracking one or more objects in the first FOV, as indicated at block 124. The same one or more objects are detected and tracked in the second FOV, as indicated at block 126. While the one or more objects are detected at the same time (e.g. same time stamp) in both the first FOV and the second FOV, determining an extent of movement of the one or more objects is determined, as indicated at block 128. The overlapping region is determined based at least in part on the extent of movement of the one or more objects, as indicated at block 130.

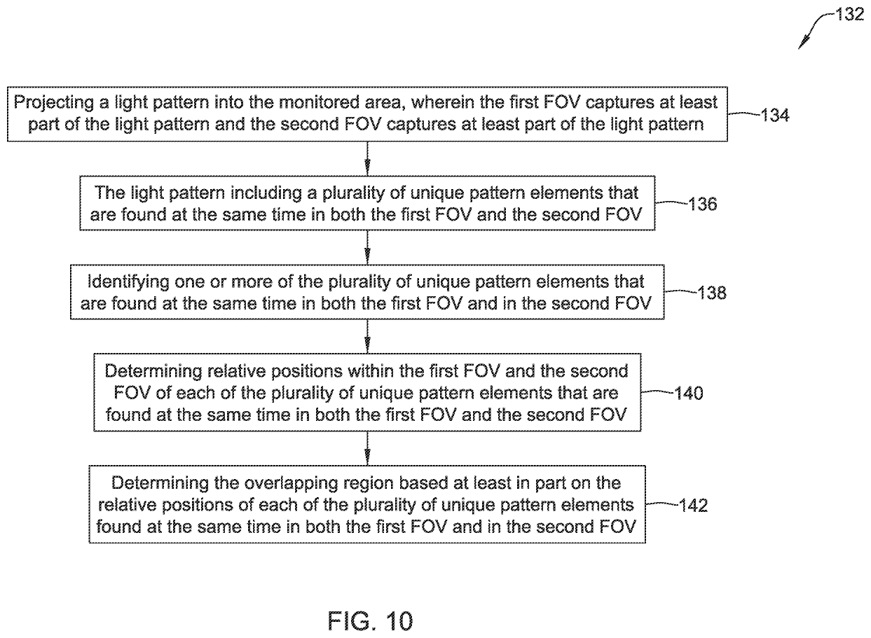

FIG. 10 is a flow diagram showing an illustrative method 132 of determining the overlapping region between the first FOV and the second FOV. The method 132 includes projecting a light pattern into the monitored area, wherein the first FOV captures at least part of the light pattern and the second FOV captures at least part of the light pattern, as indicated at block 134. The light pattern includes a plurality of unique pattern elements that can be uniquely identified, as indicated at block 136. In some cases, the light pattern includes a sequence of light patterns, wherein the sequence of light patterns includes two or more different light patterns.

One or more of the plurality of unique pattern elements that are found are identified at the same time (e.g. same time stamp) in both the first FOV and in the second FOV, as indicated at block 138. Relative positions within the first FOV and the second FOV of each of the plurality of unique pattern elements that are found at the same time (e.g. same time stamp) in both the first FOV and in the second FOV are determined, as indicated at block 140. The overlapping region is determined based at least in part on the extent of the relative positions of each of the plurality of unique pattern elements found at the same time (e.g. same time stamp) in both the first FOV and in the second FOV, as indicated at block 142.

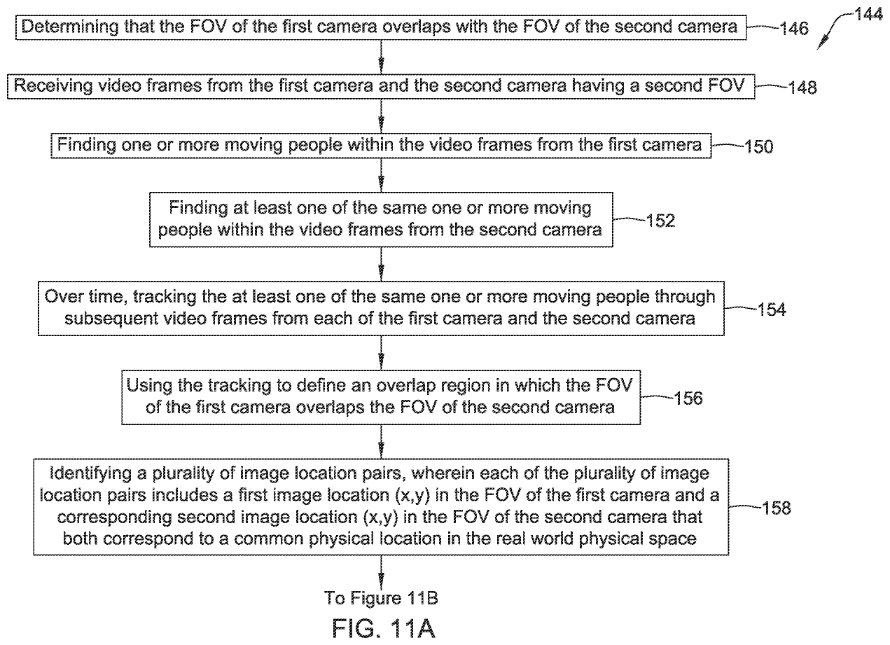

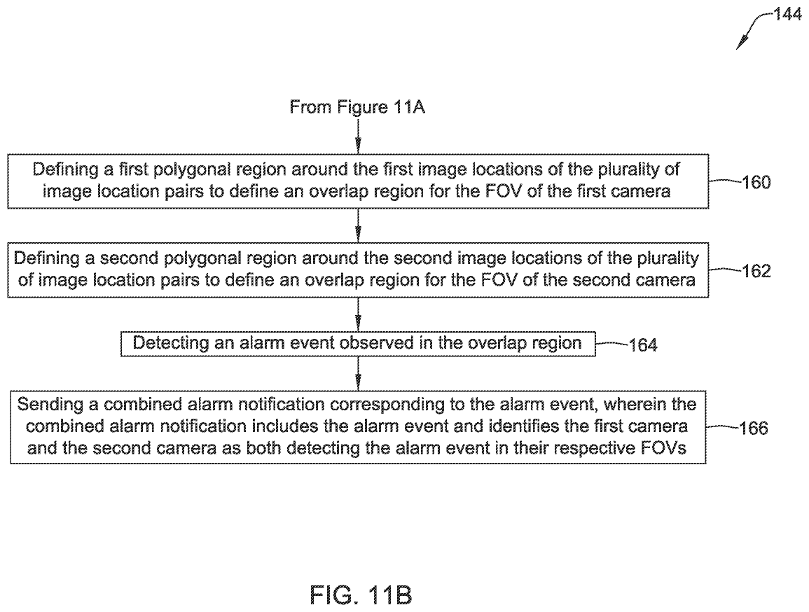

FIGS. 11A and 11B are flow diagrams that together show an illustrative method 144 for finding an overlap region between a field of view (FOV) of a first camera and a FOV of a second camera. The illustrative method includes determining that the FOV of the first camera overlaps with the FOV of the second camera, as indicated at block 146. Video frames are received from the first camera having a first FOV and the second camera having a second FOV, as indicated at block 148. One or more moving people are found within the video frames from the first camera, as indicated at block 150. At least one of the same one or more moving people are found within the video frames from the second camera, as indicated at block 152. Over time, the at least one of the same one or more moving people are tracked through subsequent video frames from each of the first camera and the second camera, as indicated at block 154. The tracking is used to define an extent of an overlapping region in which the FOV of the first camera overlaps the FOV of the second camera, as indicated at block 156.

In some instances, defining the overlapping region may continue over time as additional moving people are found within the FOV of the first camera and also found within the FOV of the second camera. In some instances, defining the overlap region is repeated over time as the FOV of the first camera and/or the FOV of the second camera are modified as a result of the first camera and/or the second camera accidently moving (e.g. bumped or intentionally moved) or being partially blocked by an obstruction.

In some cases, particularly when the FOV of the first camera and the FOV of the second camera each cover at least part of a real world physical space, the illustrative method 144 further includes identifying a plurality of image location pairs, wherein each of the plurality of image location pairs includes a first image location (x, y) in the FOV of the first camera and a corresponding second image location (x,y) in the FOV of the second camera that both correspond to a common physical location in the real world physical space, as indicated at block 158.

Continuing with FIG. 11B, a first polygonal region is defined around the first image locations of the plurality of image location pairs to define an overlap region for the FOV of the first camera, as indicated at block 160. A second polygonal region is defined around the second image locations of the plurality of image location pairs to define an overlap region for the FOV of the second camera, as indicated at block 162. In some cases, the method 144 may further include detecting an alarm event observed in the overlap region, as indicated at block 164. A combined alarm notification corresponding to the alarm event may be sent, wherein the combined alarm notification includes the alarm event and identifies the first camera and the second camera as both detecting the alarm event in their respective FOVs, as indicated at block 166.

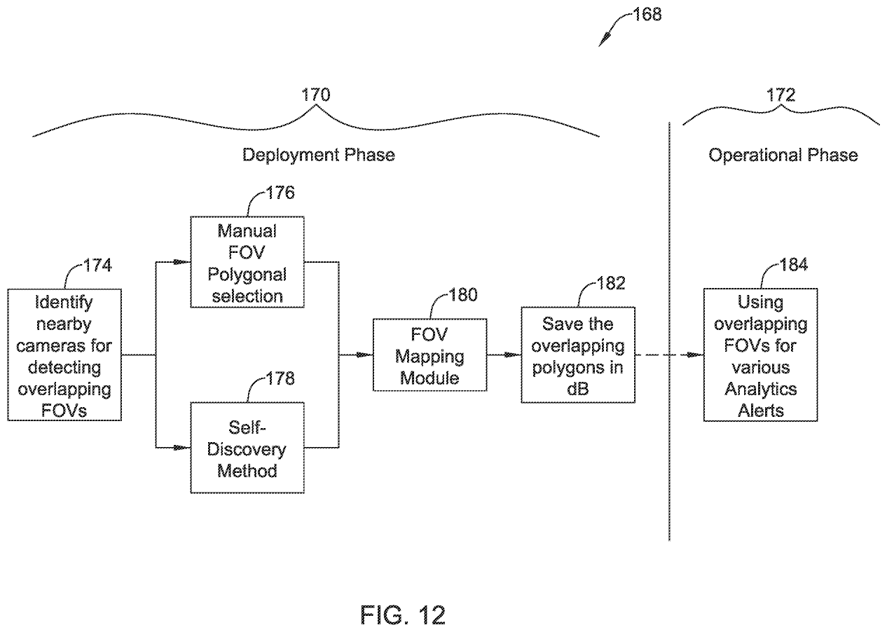

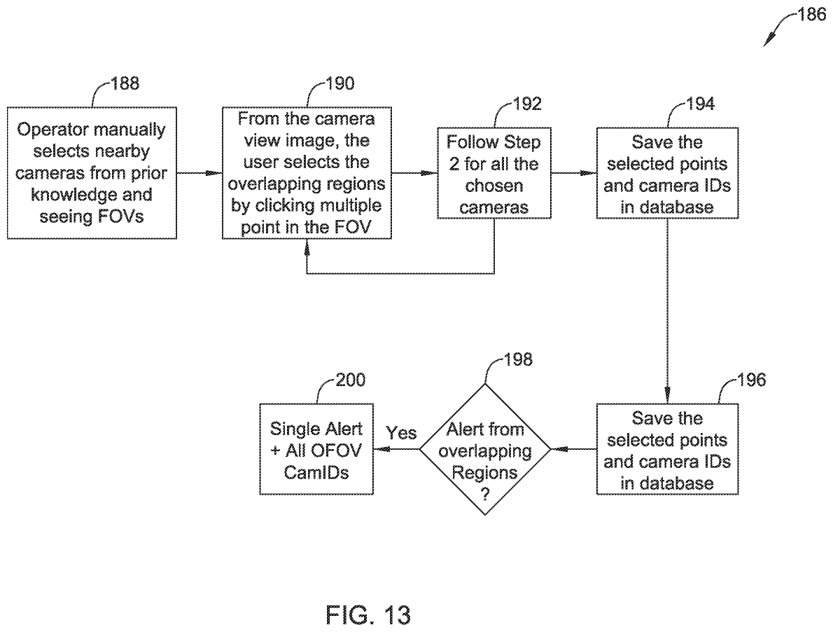

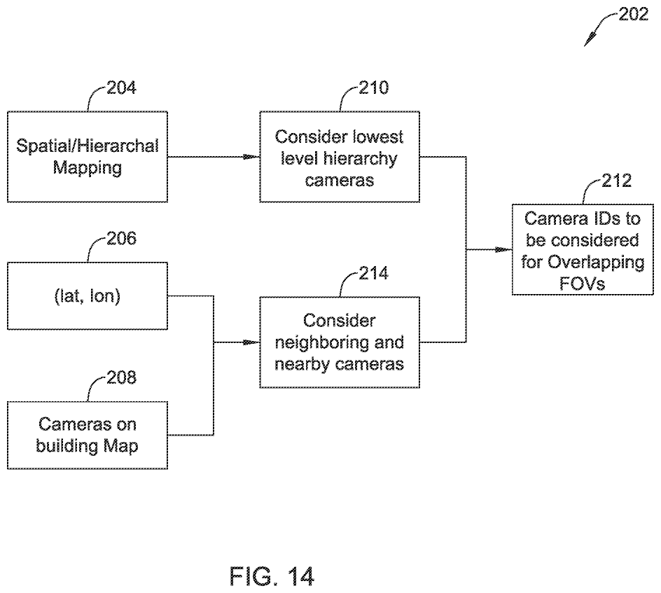

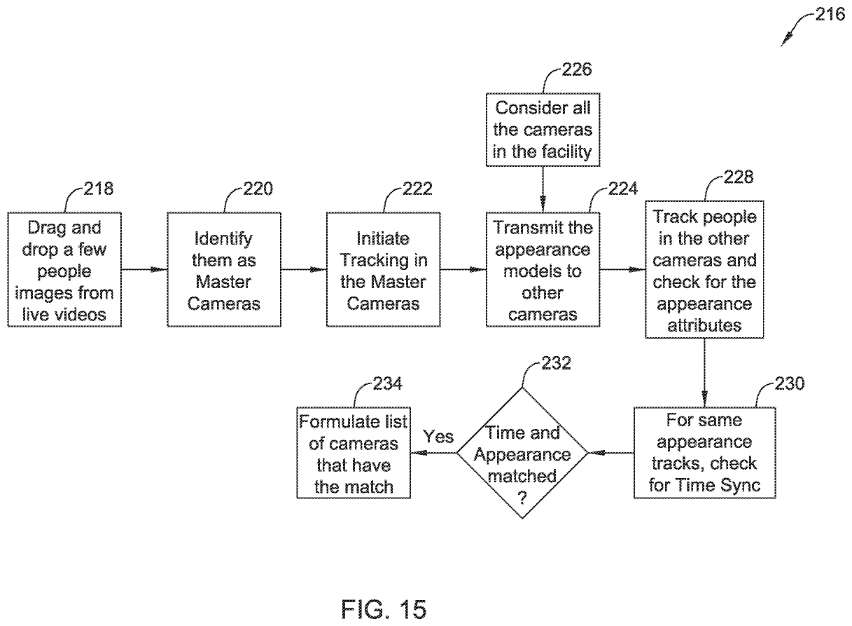

FIG. 12 is a flow diagram showing an illustrative method 168 for identifying neighboring cameras and determining how the FOV of each of the cameras overlap. In some instances, the method 168 may be considered as being divided into a deployment phase 170 and an operational phase 172. During the deployment phase, common physical locations in the real world are identified. The deployment phase can range from a few hours to a day or event a week, based on the object's presence and movement within the FOVs. As a first step, nearby cameras are identified to consider for finding out the overlapping FOVs of the cameras, as indicated at block 174. In some cases, a manual process may be used to identify the cameras and overlapping FOVs, as indicated at block 176. Further details of the manual process will be described with respect to FIG. 13. In some cases, a self-discovery method may be used, as indicated at block 178. Further details of the self-discovery method will be described with respect to FIGS. 14 and 15. As indicated at block 180, the FOV of the neighboring cameras may be mapped. Polygons defining the overlapping FOVs may be saved in a database, as indicated at block 182. During the operational phase 172, the polygons defining the overlapping FOVs may be used in providing combined alarms when the same event is detected by two or more neighboring cameras in an overlapping FOV, as indicated at block 184.

FIG. 13 is a flow diagram showing an illustrative method 186 for manually identifying cameras and overlapping FOVs. The method 186 includes an operator manually selecting nearby cameras, as indicated at block 188, by having prior knowledge of camera locations. The operator is able to manually select points that define the overlapping regions, as indicated at block 190. This is repeated for all of the chosen cameras, as indicated at block 192. Next, the selected points and cameras are saved in a database, as indicated at block 194. Subsequently, when video analytics indicate a possible event that could necessitate an alarm, the database data is retrieved, as indicated at block 196. A determination is made as to whether there are alarm for the same event in the overlapping regions, as indicated at decision block 198. If so, a single alarm is issued that includes a listing of all the overlapping FOV cameras that detected the alarm, as indicated at block 200.

FIG. 14 is a flow diagram showing an illustrative method 202 that provides an example of a self-discovery process for identifying the nearby cameras. There are various ways of having advance information as to camera location. In some cases, a hierarchal or spatial mapping of the cameras may be available, as indicated at block 204. In some cases, the latitude and longitude values for each of the cameras may be available, as indicated at block 206. In some cases, the cameras may be indicated on a building map, as indicated at block 208.

In cases in which a hierarchal or spatial mapping of the cameras is available, the lowest hierarchy level cameras may be considered, as indicated at block 210. In some cases, the cameras that are at the lowest hierarchy level may all be in the same zone or region of a facility, and thus may have a good chance of having overlapping FOVs. In other cases, whether the latitude and longitude values are known, or the camera locations are known from a building map, neighboring and nearby cameras may be considered, as indicated at block 214. In some instances, a threshold of several meters may be used in ascertaining whether cameras are neighboring, for example. In either case, this yields a listing of cameras that should be considered as possibly having overlapping FOVs, as indicated at block 212.

FIG. 15 is a flow diagram showing an illustrative method 216 that provides another example of a self-discovery process. The illustrative method 216 applies to situations in which there is no advance knowledge of camera locations. In the method 216, several images with people in them are selected, as indicated at block 218. These cameras are identified as master cameras, as indicated at block 220. These people are tracked, as indicated at block 222. Appearance models are computed and may be transmitted to the other cameras, as indicated at block 224. As indicated at block 226, all of the cameras in the facility are considered. As indicated at block 228, people are tracked in other camera views to look for the same appearances (look for same people present at the same time). If the same appearances are found, the next step is to check for time synchronization, as indicated at block 230. A determination is made at a decision block 232 as to whether the time and appearances match. If the time and appearances match, these cameras are determined to have overlapping FOVs, as indicated at block 234. A listing of cameras that have overlapping FOVs may be produced.

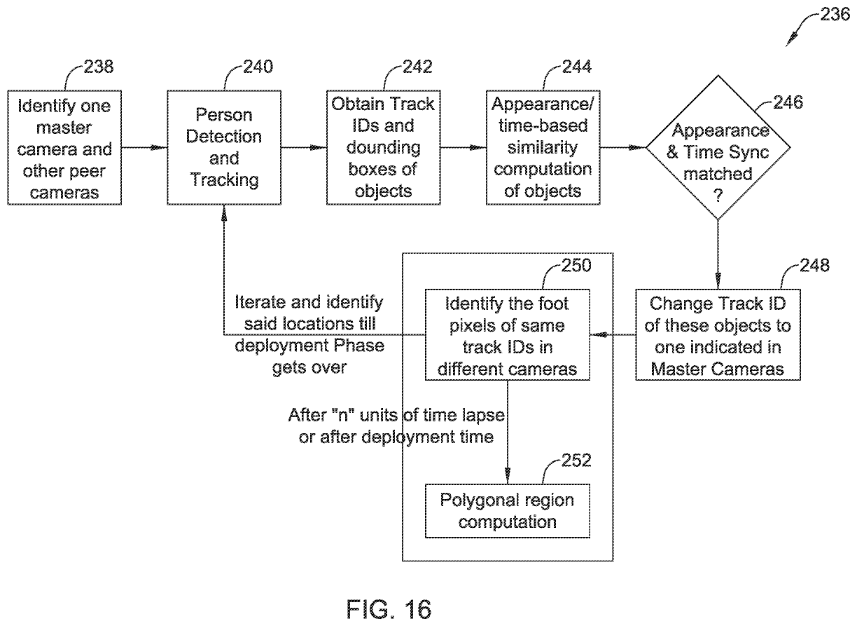

FIG. 16 is a flow diagram showing an illustrative method 236 that may be carried out within the FOV mapping module block 180 (FIG. 12). The illustrative method 236 includes identifying a master camera and several peer cameras, as indicated at block 238. Person detection and tracking is performed, as indicated at block 240. Track ID and bounding boxes of persons are obtained, as indicated at block 242. Appearance and time-based similarity are reviewed, as indicated at block 244. A determination is made whether the appearance and time synch both match, as indicated at decision block 246. If so, the track ID of the person is changed to match the track ID assigned by the master camera, as indicated at block 248. In some cases, foot positions (e.g. foot pixels) of tracked persons having the same track ID in different cameras are identified, as indicated at block 250. A polygonal region computation is performed on the tracking information. In some cases, a polygon is defined around the extend of the foot pixels in each of the FOVs, as indicated at block 252. The resulting polygon may define the overlapping region in each of the FOV. In some cases, these steps continue until a deployment phase terminates.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A method for reducing alarm notifications from a security system deploying a plurality of cameras within a monitored area, a first camera of the plurality of cameras having a first field of view (FOV) and a second camera of the plurality of cameras having a second FOV, wherein at least part of the first FOV of the first camera includes a first overlapping region that corresponds to where the second FOV of the second camera overlaps with the first FOV of the first camera, and wherein at least part of the second FOV of the second camera includes a second overlapping region that corresponds to where the first FOV of the first camera overlaps with the second FOV of the second camera, the method comprising:
processing a first video stream captured by the first camera of the security system to detect an alarm event observed in the first overlapping region of the FOV of the first camera;
processing a second video stream captured by the second camera of the security system to detect the same alarm event observed in the second overlapping region of the FOV of the second camera; and
sending a combined alarm notification corresponding to the alarm event, wherein the combined alarm notification includes the alarm event and identifies the first camera and the second camera as both detecting the alarm event in their respective FOVs.

2. The method of claim 1, further comprising receiving user input that manually defines the first overlapping region and the second overlapping region.

3. The method of claim 2, wherein receiving user input that manually defines the first overlapping region and the second overlapping region comprises:
receiving user inputs relative to the first FOV that define vertices of the first overlapping region; and
receiving user inputs relative to the second FOV that define vertices of the second overlapping region.

4. The method of claim 1, further comprising automatically defining the first overlapping region and the second overlapping region.

5. The method of claim 4, wherein automatically defining the first overlapping region and the second overlapping region comprises:
processing the first video stream captured by the first camera of the security system and processing the second video stream captured by the second camera of the security system;
detecting and tracking one or more objects in the first FOV;
detecting and tracking the same one or more objects in the second FOV;
while the one or more objects are detected at the same time in both the first FOV and the second FOV, determining a first extent of movement of the one or more objects in the first FOV;
while the one or more objects are detected at the same time in both the first FOV and the second FOV, determining a second extent of movement of the one or more objects in the second FOV;
determining the first overlapping region in the first FOV based at least in part on the first extent of movement in the first FOV; and
determining the second overlapping region in the second FOV based at least in part on the second extent of movement in the second FOV.

6. The method of claim 4, wherein automatically defining the first overlapping region and the second overlapping region comprises:
projecting a light pattern into the monitored area, wherein the first FOV captures at least part of the light pattern and the second FOV captures at least part of the light pattern;
the light pattern including a plurality of unique pattern elements that can be uniquely identified;
processing the first video stream captured by the first camera of the security system and processing the second video stream captured by the second camera of the security system to identify one or more of the plurality of unique pattern elements that are found at the same time in both the first FOV and in the second FOV;
determining relative positions within the first FOV and the second FOV of each of the plurality of unique pattern elements that are found at the same time in both the first FOV and in the second FOV;
determining the first overlapping region in the first FOV based at least in part on the relative positions within the first FOV of each of the plurality of unique pattern elements found at the same time in both the first FOV and in the second FOV; and
determining the second overlapping region in the second FOV based at least in part on the relative positions within the second FOV of each of the plurality of unique pattern elements found at the same time in both the first FOV and in the second FOV.

7. The method of claim 6, wherein the light pattern comprises a sequence of light patterns, wherein the sequence of light patterns includes two or more different light patterns.

8. The method of claim 1, further comprising:
determining candidate ones of the plurality of cameras as possibly having overlapping FOVs; and
determining whether the candidate ones of the plurality of cameras have overlapping FOVs.

9. The method of claim 8, wherein determining candidate ones of the plurality of cameras as possibly having overlapping FOVs comprises identifying cameras that are neighboring cameras in the security system.

10. A method for reducing alarm notifications from a security system deploying a plurality of cameras within a monitored area, at least some of the plurality of cameras having a field of view (FOV) that overlaps with that of at least one other of the plurality of cameras, the method comprising:
receiving video frames from each of a first camera having a first FOV and a second camera having a second FOV, where a determination has been made that the first FOV overlaps the second FOV;
detecting one or more objects within the video frames from the first camera;
detecting at the same time at least one of the same one or more objects within the video frames from the second camera;
determining an overlapping region between the first FOV and the second FOV based at least in part on the one or more detected objects;
detecting an alarm event in the overlapping region between the first FOV and the second FOV; and
sending a combined alarm notification corresponding to the alarm event.

11. The method of claim 10, wherein the combined alarm notification includes the alarm event and identifies the first camera and the second camera as both detecting the alarm event in their respective FOVs.

12. The method of claim 10, wherein determining the overlapping region comprises fine tuning the overlapping region as additional objects are found within the FOV of the first camera and the same additional objects are found at the same time within the FOV of the second camera.

13. The method of claim 10, wherein determining the overlapping region between the first FOV and the second FOV comprises:
detecting and tracking one or more objects in the first FOV;
detecting and tracking the same one or more objects in the second FOV;
while the one or more objects are detected at the same time in both the first FOV and the second FOV, determining an extent of movement of the one or more objects; and
determining the overlapping region based at least in part on the extent of movement of the one or more objects.

14. The method of claim 10, wherein determining the overlapping region between the first FOV and the second FOV comprises:
projecting a light pattern into the monitored area, wherein the first FOV captures at least part of the light pattern and the second FOV captures at least part of the light pattern;
the light pattern including a plurality of unique pattern elements that can be uniquely identified;
identifying one or more of the plurality of unique pattern elements that are found at the same time in both the first FOV and in the second FOV;
determining relative positions within the first FOV and the second FOV of each of the plurality of unique pattern elements that are found at the same time in both the first FOV and in the second FOV; and
determining the overlapping region based at least in part on the relative positions of each of the plurality of unique pattern elements found at the same time in both the first FOV and in the second FOV.

15. The method of claim 14, wherein the light pattern comprises a sequence of light patterns, wherein the sequence of light patterns includes two or more different light patterns.

16. A method for finding an overlap region between a field of view (FOV) of a first camera and a FOV of a second camera, the method comprising:
determining that the FOV of the first camera overlaps with the FOV of the second camera;
receiving video frames from the first camera and the second camera having a second FOV;
finding one or more moving people within the video frames from the first camera;
finding at least one of the same one or more moving people within the video frames from the second camera;
over time, tracking the at least one of the same one or more moving people through subsequent video frames from each of the first camera and the second camera; and
using the tracking to define an overlap region in which the FOV of the first camera overlaps the FOV of the second camera.

17. The method of claim 16, wherein the FOV of the first camera and the FOV of the second camera each cover at least part of a real world physical space, the method further comprising:
identifying a plurality of image location pairs, wherein each of the plurality of image location pairs includes a first image location (x, y) in the FOV of the first camera and a corresponding second image location (x,y) in the FOV of the second camera that both correspond to a common physical location in the real world physical space;
defining a first polygonal region around the first image locations of the plurality of image location pairs to define an overlap region for the FOV of the first camera; and
defining a second polygonal region around the second image locations of the plurality of image location pairs to define an overlap region for the FOV of the second camera.

18. The method of claim 16, wherein defining the overlap region continues over time as additional moving people are found within the FOV of the first camera and also found within the FOV of the second camera.

19. The method of claim 16, wherein defining the overlap region is repeated over time as the FOV of the first camera and/or the FOV of the second camera are modified as a result of the first camera and/or the second camera accidently moving or being partially blocked by an obstruction.

20. The method of claim 16, further comprising:
detecting an alarm event observed in the overlap region; and
sending a combined alarm notification corresponding to the alarm event, wherein the combined alarm notification includes the alarm event and identifies the first camera and the second camera as both detecting the alarm event in their respective FOVs.
